(19) United States
(12) Patent Application Publication
(10) Pub. No.: US 2020/0408223 A1
(43) Pub. Date: Dec. 31, 2020

(54) CEILING FAN

(71) Applicant: Panasonic Intellectual Property Management Co., Ltd., Osaka (JP)

(72) Inventors: Hiroyuki KURAMOCHI, Aichi (JP); Fumiya SUZUKI, Aichi (JP)

(73) Assignee: Panasonic Intellectual Property Management Co., Ltd., Osaka (JP)

(21) Appl. No.: 16/070,500

(22) PCT Filed: Jan. 19, 2017
(86) PCT No.: PCT/JP2017/001638

§ 371 Date: Jul. 16, 2018

(30) Foreign Application Priority Data
Jan. 21, 2016 (JP) 2016-009719

(51) Int. Cl. F04D 29/58; F04D 25/08; F04D 25/06; F21V 33/00; F21V 19/00; F21V 29/70

(52) U.S. Cl. CPC F04D 29/582; F04D 25/088; F04D 25/06; F21Y 2115/10; F21V 19/0015; F21V 29/70; F21V 33/0096

(57) ABSTRACT

A ceiling fan includes a support rod that is capable of engaging with a ceiling, a motor that is provided at a lower portion of the support rod, blades (5) that are detachably attached to the motor, and lighting unit (7) that is provided at a lower portion of the motor. Lighting unit (7) includes upper lighting cover (16), lower lighting cover (17) that covers an area below upper lighting cover (16), board (19) which is disposed between lower lighting cover (17) and upper lighting cover (16), and on which a light-emitting component is installed, and heat-dissipating unit (18) that is provided between board (19) and upper lighting cover (16), and dissipates heat from board (19). Upper lighting cover (16) and lower lighting cover (17) are formed of a resin, and opening (31) for dissipating heat is provided at a center portion of upper lighting cover (16).

### TECHNICAL FIELD

The present invention relates to a ceiling fan provided with lighting.

### BACKGROUND ART

In the related art, a ceiling fan of this type includes a support rod that is capable of engaging with a ceiling, a motor that is provided at a lower portion of the support rod, blades that are detachably attached to the motor, a controller that is provided at a lower portion of the motor, and a lighting unit that is provided on a lower surface of the controller. The lighting unit includes a heat-dissipating unit that is fixed to the controller, a board on which a light-emitting component is installed, a bowl-shaped lower lighting cover of which an upper portion is opened, and a substantially cylindrical case. The board and the lower lighting cover are fixed to the heat-dissipating unit and the case is configured to be detachably attached to the heat-dissipating unit. In a case where the blades are installed in the motor, work is performed in a state where the case is detached from the heat-dissipating unit (for example, see PTL 1).

### CITATION LIST

### Patent Literature

PTL 1: Japanese Patent Unexamined Publication No. 2015-55157

### SUMMARY OF THE INVENTION

In such a ceiling fan of the related art, in a case where the blades are installed in the motor, if the case is detached from the heat-dissipating unit, a peripheral portion of the heat-dissipating unit is exposed. Therefore, in a case where the blades are installed in the motor, when static electricity is generated from the worker, the static electricity jumps to the exposed heat-dissipating unit, a current flows from the heat-dissipating unit to the board, and there is a problem that the light-emitting component may break down.

An object of the invention is to reduce jumping of static electricity to a heat-dissipating unit and flowing of a current from the heat-dissipating unit to a board.

In order to achieve the object, there is provided a ceiling fan according to the invention including: a support rod that is capable of engaging with a ceiling; a motor that is provided at a lower portion of the support rod; a blade that is detachably attached to the motor; and a lighting unit that is provided at a lower portion of the motor. In addition, the lighting unit includes an upper lighting cover, a lower lighting cover that covers an area below the upper lighting cover, a board which is disposed between the lower lighting cover and the upper lighting cover, and on which a light-emitting component is installed, and a heat-dissipating unit that is provided between the board and the upper lighting cover, and dissipates heat from board. Furthermore, in the ceiling fan according to the invention, the upper lighting cover and the lower lighting cover are formed of a resin, and an opening for dissipating heat is provided at a center portion of the upper lighting cover. Therefore, an intended object can be obtained.

As described above, in the invention, the upper lighting cover and the lower lighting cover are formed of the resin, and the opening for dissipating heat is provided at the center portion of the upper lighting cover.

That is, since the peripheral portion of the motor in which the blade is installed and the heat-dissipating opening are separated from each other, when attaching the blade to the motor, it is possible to reduce jumping of static electricity to the heat-dissipating unit via the opening and flowing of a current from the heat-dissipating unit to the board.

### BRIEF DESCRIPTION OF DRAWINGS

FIG. 1 is a perspective view illustrating a ceiling fan of an embodiment of the invention.

FIG. 2 is a sectional view illustrating the ceiling fan.

FIG. 3 is an enlarged sectional view of a portion surrounded by a two-dot chain line in FIG. 2.

FIG. 4 is an exploded perspective view illustrating a lighting unit of the ceiling fan.

FIG. 5 is an exploded perspective view illustrating a lighting unit of the ceiling fan.

FIG. 6 is a perspective view illustrating an upper lighting cover of the ceiling fan.

### DESCRIPTION OF EMBODIMENT

Hereinafter, an embodiment of the invention will be described with reference to the drawings.

In addition, with respect to each member described below, a portion on an upper side in the drawings is referred to as an upper portion and a portion on a lower side in the drawings is referred to as a lower portion. In addition, with respect to each member described below, a surface on the upper side in the drawings is referred to as an upper surface and a surface on the lower side is referred to as a lower surface. In addition, in the following description, upward in the drawings is referred to as upward and downward in the drawings is referred to as downward.

### Embodiment

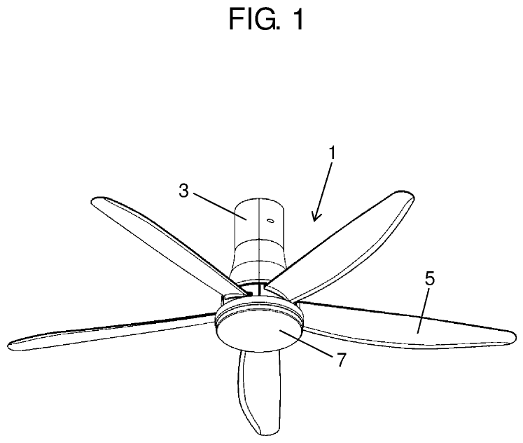

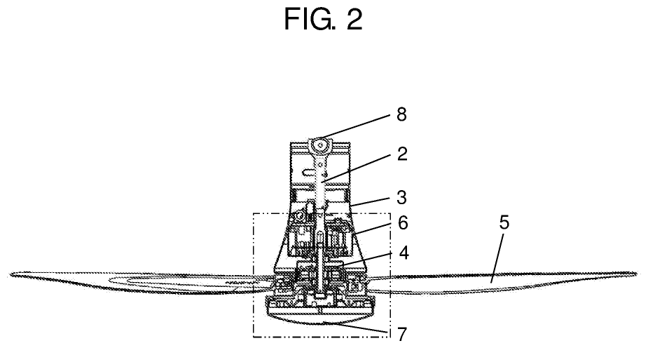

FIG. 1 is a perspective view illustrating a ceiling fan of an embodiment. FIG. 2 is a sectional view illustrating the ceiling fan of the embodiment.

As illustrated in FIGS. 1 and 2, ceiling fan 1 includes support rod 2, pipe cover 3, motor 4, blade 5, controller 6, and lighting unit 7.

Support rod 2 has a hollow rod shape, hanging portion 8 which is capable of engaging with a ceiling is provided at an upper portion, and motor 4 is fixed to a lower portion thereof. Ceiling fan 1 includes cylindrical pipe cover 3 around support rod 2. Ceiling fan 1 is hung from a ceiling surface via hanging portion 8.

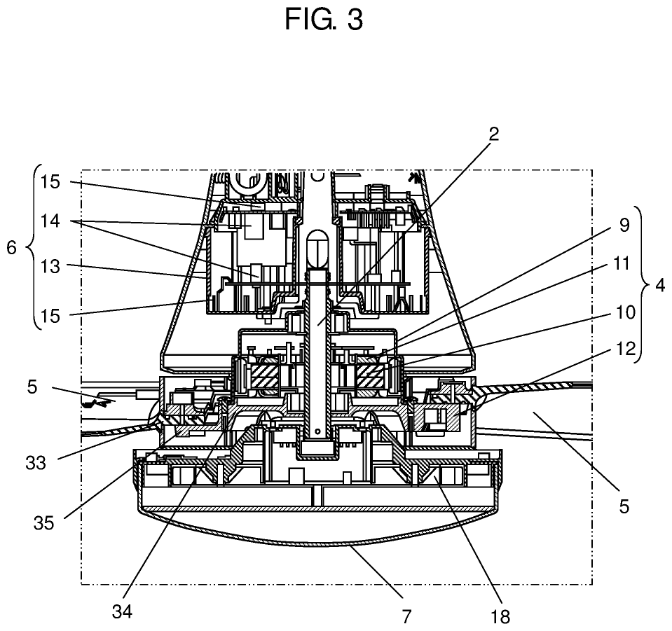

FIG. 3 is an enlarged sectional view of a portion surrounded by a two-dot chain line in FIG. 2.

As illustrated in FIG. 3, motor 4 is an outer rotor motor and includes rotor 9, stator core 10, stator winding 11, and support portion 12.

Rotor 9 has a cylindrical shape in which an upper surface and a lower surface (surface on a lower side in the drawing) are closed, and is rotatably installed in support rod 2, so that a central axis is a rotation axis. The central axis of support rod 2 and the central axis of rotor 9 are coaxially disposed. Motor 4 includes stator core 10 which is a plurality of iron plates fixed to support rod 2, and stator winding 11 which is a copper wire wound around a hole (not illustrated) of stator core 10 on the inside of rotor 9.

Support portion 12 is a plurality of plates extending outward from a lower portion of rotor 9. Support portion 12 is formed integrally with rotor 9. A material thereof is a metal and, for example, is aluminum or an aluminum alloy.

Blade 5 has a substantially rectangular flat plate shape and one short side of the substantially rectangular flat plate shape is detachably installed in support portion 12. When a voltage is applied to stator winding 11, rotor 9, support portion 12, and blades 5 rotate, and air is blown by blades 5.

Controller 6 is provided over motor 4 and includes control case 13 and control board 14 provided in control case 13. Controller 6 is operated based on a signal which is received from a remote controller which is described later.

Control case 13 has a substantially cylindrical shape of which an upper surface and a lower surface are closed, and includes a plurality of vent holes 15 at the upper portion and the lower portion thereof. Heat generated in control board 14 is dissipated by vent holes 15 to the outside of control case 13.

Control board 14 is electrically connected to motor 4, lighting unit 7, and a power supply wire (not illustrated) extending from a ceiling back side. Control board 14 controls motor 4 and lighting unit 7.

Lighting unit 7 is provided below motor 4 and illuminates light downward from the lower surface.

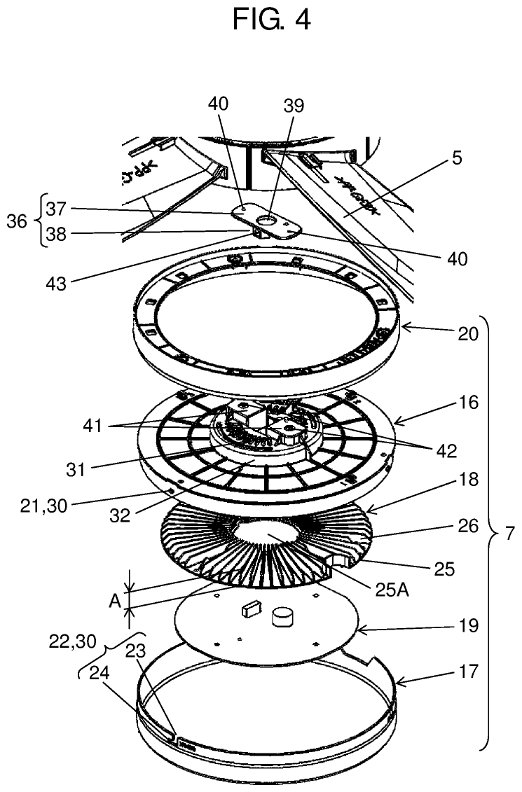

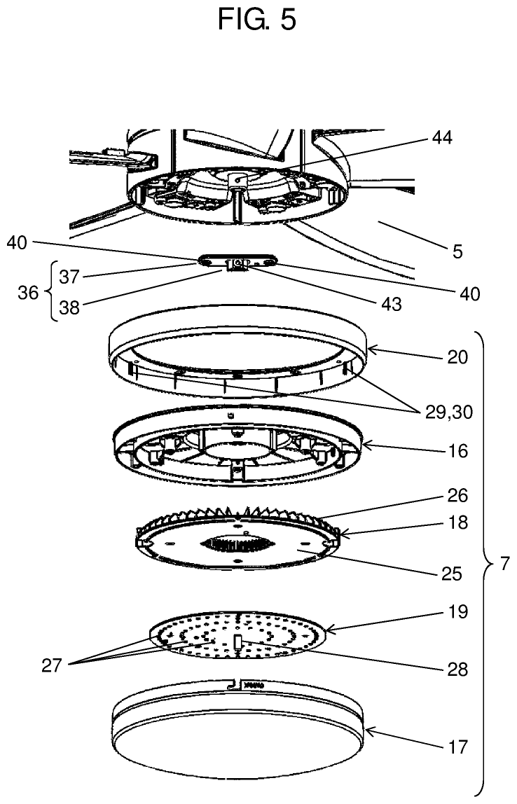

FIGS. 4 and 5 are exploded perspective views illustrating the lighting unit of the ceiling fan of the embodiment.

As illustrated in FIGS. 4 and 5, lighting unit 7 includes upper lighting cover 16, lower lighting cover 17, heat-dissipating unit 18, board 19, and cover 20.

Upper lighting cover 16 has a substantially cylindrical shape of which an upper portion is closed, and is provided with upper fixing portion 21 that is a protrusion protruding outward from a cylindrical side surface on the cylindrical side surface.

Lower lighting cover 17 has a bowl shape which is opened upward and is provided with lower fixing portion 22 that is an L-shaped notch at an upper end portion. Lower fixing portion 22 includes first notch 23 extending downward from an upper end of lower lighting cover 17 and second notch 24 extending in a horizontal direction from a lower end of first notch 23. A material of lower lighting cover 17 is resin material having transparency and reflectivity to light, and, for example, is a translucent polycarbonate containing a diffusion material. Since lower lighting cover 17 is translucent, a part of light hitting lower lighting cover 17 passes through lower lighting cover 17. In addition, since the material of lower lighting cover 17 is the resin material containing the diffusion material, a part of the light hitting lower lighting cover 17 is reflected by an inner surface of lower lighting cover 17.

Heat-dissipating unit 18 includes disc-shaped disk portion 25 and a plurality of elongated plate-like protrusions 26 extending upward from an upper surface of disk portion 25. Circular hole 25A is formed at a center of disk portion 25. Protrusion 26 is radially provided from the center of hole 25A and has an elongated plate shape extending in a radial direction. Disk portion 25 and protrusions 26 are molded integrally with a metal, and a material thereof is, for example, aluminum or an aluminum alloy. Heat-dissipating unit 18 is fixed to upper lighting cover 16.

Board 19 is fixed to heat-dissipating unit 18 and lower lighting cover 17 is fixed to upper lighting cover 16, so that board 19 is covered by lower lighting cover 17 and upper lighting cover 16. A plurality of light-emitting components 27 are installed on a lower surface of board 19 and one receiving portion 28 is installed at a center thereof. The lower surface of board 19 is subjected to a surface treatment so that the light reflected by lower lighting cover 17 is reflected again by board 19. An example of the surface treatment is to paint white.

An example of light-emitting component 27 is a rectangular plate-like LED chip that is a light emitting element. The plurality of light-emitting components 27 are disposed radially around receiving portion 28. In a state where ceiling fan 1 is hung from the ceiling surface, the light from light-emitting component 27 is emitted in the vertical direction and spreads appropriately 60 degrees in the vertical direction to be emitted downward. The light emitted from light-emitting component 27 is repeatedly reflected by the inner surface of lower lighting cover 17 and the lower surface of board 19, and a part of the light passes through lower lighting cover 17.

Receiving portion 28 is provided at a center of a LED chip mounting surface of board 19 and is capable of receiving a signal transmitted from a remote controller (not illustrated) via lower lighting cover 17. An example of the signal is due to infrared radiation.

Cover 20 has a planar ring and a cylindrical side surface extending from an outer periphery of the ring, and covers a peripheral portion of the upper surface and the side surface of upper lighting cover 16, and the upper end portion of lower lighting cover 17. Ribs extending in the vertical direction protrude from the inner surface of the side surface of cover 20. The ribs are retaining portions 29.

Upper lighting cover 16 and lower lighting cover 17 are fixed by cover fixing portion 30. Cover fixing portion 30 includes upper fixing portion 21, lower fixing portion 22, and retaining portion 29.

In the configuration described above, a method of assembling upper lighting cover 16, lower lighting cover 17, heat-dissipating unit 18, board 19, and cover 20 will be described.

First, board 19 is fixed to heat-dissipating unit 18. Next, heat-dissipating unit 18 to which board 19 is fixed is attached to upper lighting cover 16. Thereafter, upper lighting cover 16 to which heat-dissipating unit 18 and board 19 are attached is covered with lower lighting cover 17. In this case, the protrusion, which is upper fixing portion 21 of upper lighting cover 16, enters second notch 24 via first notch 23 that is in lower fixing portion 22 of lower lighting cover 17. That is, first notch 23 of lower lighting cover 17 is covered with upper fixing portion 21 of upper lighting cover 16 to be fitted, and lower lighting cover 17 may be rotated with respect to upper lighting cover 16, so that upper fixing portion 21 enters second notch 24. In addition, upper lighting cover 16 may be rotated with respect to lower lighting cover 17. Therefore, upper fixing portion 21 of upper lighting cover 16 enters second notch 24 and is caught, so that lower lighting cover 17 can move in the horizontal direction with respect to upper lighting cover 16, but cannot move in the vertical direction (vertical direction in the drawing).

Next, upper lighting cover 16 and lower lighting cover 17 are covered with cover 20 from above. In this case, cover 20 covers upper lighting cover 16 and lower lighting cover 17, so that a lower end portion of retaining portion 29 of cover 20 enters first notch 23 that is in lower fixing portion 22 of lower lighting cover 17. According to the configuration, when lower lighting cover 17 is rotated with respect to upper lighting cover 16 in the horizontal direction, first notch 23 is in contact with retaining portion 29, or second notch 24 is in contact with upper fixing portion 21. Therefore, lower lighting cover 17 cannot rotate with respect to upper lighting cover 16. According to the configuration described above, lower lighting cover 17 is attached to upper lighting cover 16 so as to restrict movement in the vertical direction and a rotation direction. That is, upper lighting cover 16 and lower lighting cover 17 are stably fixed.

Next, an operation of ceiling fan 1 will be described. In the embodiment, the operation of ceiling fan 1 is controlled by a remote controller. First, a signal is transmitted from the remote controller to ceiling fan 1. The transmitted signal is received by receiving portion 28 provided at the center of board 19. The signal received by receiving portion 28 is transmitted to controller 6 and controller 6 rotates motor 4. Motor 4 rotates, blades 5 rotates, and then air is blown. In addition, when a lighting button of the remote controller is pushed, since receiving portion 28 receives a signal for lighting, lighting unit 7 can be turned on, illuminance can be switched, and the illumination can be turned off.

A characteristic in the embodiment is a structure of lighting unit 7. Specifically, lighting unit 7 includes upper lighting cover 16, bowl-shaped lower lighting cover 17 which covers an area below upper lighting cover 16 and of which the upper portion is opened, board 19 which is disposed between lower lighting cover 17 and upper lighting cover 16, and on which the light-emitting component is installed, and heat-dissipating unit 18 which is sandwiched between upper lighting cover 16 and board 19. Upper lighting cover 16 and lower lighting cover 17 are formed of resin and opening 31 for dissipating heat is provided at the center portion of upper lighting cover 16. Heat-dissipating unit 18 and board 19 are disposed on the inside of upper lighting cover 16 and lower lighting cover 17 which are formed of resin, and opening 31 of upper lighting cover 16 communicates the inside of upper lighting cover 16 and lower lighting cover 17 with the outside of upper lighting cover 16 and lower lighting cover 17.

As described above, heat-dissipating unit 18 is not exposed and is disposed on the inside of upper lighting cover 16 and lower lighting cover 17, and a worker is not directly in contact with heat-dissipating unit 18. Therefore, in a case where the worker attaches blades 5 at the site, it is possible to reduce jumping of static electricity from the worker to heat-dissipating unit 18 and flowing of a current from heat-dissipating unit 18 to board 19.

In addition, heat-dissipating unit 18 is disposed on the inside of upper lighting cover 16 and lower lighting cover 17 which are formed of resin, and is not exposed. However, opening 31 for dissipating heat is provided at the center portion of upper lighting cover 16. Therefore, heat from heat-dissipating unit 18 on the inside of upper lighting cover 16 and lower lighting cover 17 can be dissipated from opening 31 to the outside of upper lighting cover 16 and lower lighting cover 17.

Furthermore, in a case where blades 5 are attached, the peripheral portion of motor 4 in which blades 5 are installed is separated from opening 31 for dissipating heat. Therefore, static electricity is hard to jump to heat-dissipating unit 18 via opening 31 and it is possible to reduce flowing of the current from heat-dissipating unit 18 to board 19.

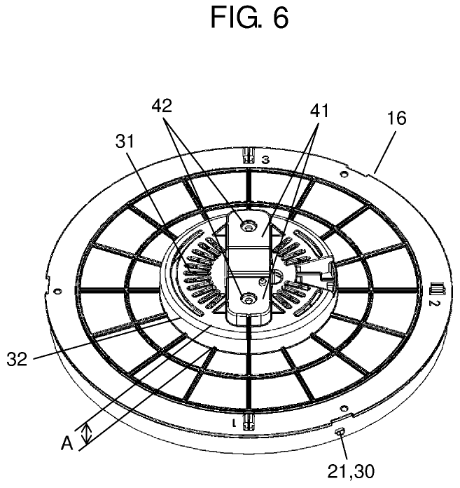

FIG. 6 is a perspective view illustrating the upper lighting cover of the ceiling fan of the embodiment.

As illustrated in FIG. 6, upper lighting cover 16 has protrusion portion 32 protruding upward at the center portion and includes opening 31 at protrusion portion 32. In addition, as illustrated in FIG. 4, cylindrical protrusion portion 32, of which an upper surface protruding upward by predetermined distance A from the upper surface of upper lighting cover 16 is closed, is provided at the center portion of the upper surface of upper lighting cover 16. Opening 31 for dissipating heat is provided on the upper surface of protrusion portion 32. Therefore, a distance from the upper end of heat-dissipating unit 18 to opening 31 for dissipating heat is further separated by predetermined distance A. Openings 31 for dissipating heat are a plurality of elongated holes radially extending outward from the center portion of protrusion portion 32.

Therefore, a creepage distance from the peripheral portion of motor 4 in which blades 5 are installed to the upper end of heat-dissipating unit 18 is extended, so that in a case where blades 5 are installed, it is possible to further reduce jumping of static electricity from the worker to heat-dissipating unit 18 via openings 31 and flowing of the current from heat-dissipating unit 18 to board 19.

In addition, opening 31 for dissipating heat faces the lower surface of motor 4 at the center portion of the upper surface of upper lighting cover 16, is positioned inward from the peripheral portion of motor 4, and is a hole penetrating in the vertical direction.

Therefore, opening 31 is positioned inward from the peripheral portion of motor 4, so that in case where blades 5 are installed on the peripheral portion of motor 4, a distance between the hand of the worker and opening 31 becomes long. As a result, it is possible to reduce jumping of static electricity from the hand of the worker to heat-dissipating unit 18 via openings 31 and flowing of the current from heat-dissipating unit 18 to board 19.

Furthermore, motor 4 includes rotating rotor 9 and a plurality of support portions 12 to which blades 5 extending from rotor 9 are attached. Blade 5 includes blade installing portion 33 which is installed in support portion 12. Support portion 12 extends outward from the lower portion of the side surface of rotor 9. Specifically, support portion 12 includes a plurality (five, for example) of first support portions 34 extending obliquely outwardly and downwardly from the lower portion of the side surface of rotor 9 and second support portion 35 extending outward in the horizontal direction from a tip of first support portion 34. Blade installing portion 33 of blade 5 is installed in an upper surface of second support portion 35 and is fixed from above with screws.

As described above, since the plurality of support portions 12 to which blades 5 are attached extend outward from the lower portion of the side surface of rotor 9, a distance from support portion 12 to opening 31 for dissipating heat is extended. Therefore, it is possible to further reduce jumping of static electricity from the worker to heat-dissipating unit 18 via openings 31 and flowing of the current from heat-dissipating unit 18 to board 19.

In addition, lighting unit 7 is configured to be detachably attached to the lower end portion of support rod 2 by fixing component 36. Fixing component 36 includes elongated flat plate-like flat plate portion 37 and cylinder-shaped cylinder portion 38 extending downward from a lower surface of flat plate portion 37. Flat plate portion 37 includes hole 39 that is a circular hole at a center and screw holes 40 which are two circular holes on both short sides. Hole 39 communicates with an inside of the cylinder portion and a lower end portion of support rod 2 is capable of inserting into the inside of the cylinder portion via hole 39. Convex portion 32 of upper lighting cover 16 includes two platform portions 41 protruding further upward from the surface on which openings 31 are provided, two platform portions 41 respectively have holes 42, and holes 42 face screw holes 40 of the flat plate portion. Cylinder portion 38 includes hole 43 penetrating in the horizontal direction. Screw hole 44 is provided at the lower end portion of support rod 2 so as to face hole 43.

In the configuration described above, a fixing method of lighting unit 7 and support rod 2 will be described. First, fixing component 36 is attached to upper lighting cover 16. Specifically, cylinder portion 38 of fixing component 36 enters between two platform portions 41 of lighting unit 7 and flat plate portion 37 of fixing component 36 is placed on the upper surfaces of platform portions 41, so that two screw holes 40 of flat plate portion 37 of fixing component 36 respectively communicate with holes 42 of two platform portions 41. A screw is screwed to screw hole 40 via hole 42 and fixing component 36 is fixed to platform portions 41.

Next, upper lighting cover 16 to which fixing component 36 is fixed, lower lighting cover 17, heat-dissipating unit 18, board 19, and cover 20 are assembled. In this state, the lower end portion of support rod 2 is inserted to enter the inside of cylinder portion 38 via hole 39 of fixing component 36, the screw is screwed into screw hole 44 of the lower end portion of support rod 2 via hole 43 of cylinder portion 38, and lighting unit 7 is fixed to support rod 2.

As described above, in a state where upper lighting cover 16 to which fixing component 36 is fixed, lower lighting cover 17, heat-dissipating unit 18, board 19, and cover 20 are assembled, that is, in a state where heat-dissipating unit 18 is not exposed and is disposed on the inside of upper lighting cover 16 and lower lighting cover 17, lighting unit 7 can be fixed to the lower end portion of support rod 2. Therefore, in a case where ceiling fan 1 is assembled at a factory, the worker cannot be directly in contact with heat-dissipating unit 18, it is possible to reduce jumping of static electricity from the worker to heat-dissipating unit 18 and flowing of the current from heat-dissipating unit 18 to board 19.

In addition, as illustrated in FIG. 3, controller 6 is provided over motor 4. Specifically, a part of controller 6 is disposed above blades 5 extending in the horizontal direction from motor 4 and a part of heat-dissipating unit 18 is disposed below blades 5.

Therefore, since motor 4 and blades 5 which are rotating objects are provided between lighting unit 7 that generates heat and controller 6, lighting unit 7 and controller 6 are liable to dissipate heat by the rotation of motor 4 and blades 5 compared to a case where lighting unit 7 and controller 6 are adjacent to each other.

### INDUSTRIAL APPLICABILITY

The present invention is useful as a ceiling fan for domestic use or office use.

### REFERENCE MARKS IN THE DRAWINGS

1 CEILING FAN
2 SUPPORT ROD
3 PIPE COVER
4 MOTOR
5 BLADE
6 CONTROLLER
7 LIGHTING UNIT
8 HANGING PORTION
9 ROTOR
10 STATOR CORE
11 STATOR WINDING
12 SUPPORT PORTION
13 CONTROL CASE
14 CONTROL BOARD
15 VENT HOLE
16 UPPER LIGHTING COVER
17 LOWER LIGHTING COVER
18 HEAT-DISSIPATING UNIT
19 BOARD
20 COVER
21 UPPER FIXING PORTION
22 LOWER FIXING PORTION
23 FIRST NOTCH
24 SECOND NOTCH
25 DISK PORTION
26 PROTRUSION
25A HOLE
27 LIGHT-EMITTING COMPONENT
28 RECEIVING PORTION
29 RETAINING PORTION
30 COVER FIXING PORTION
31 OPENING
32 CONVEX PORTION
33 BLADE INSTALLING PORTION
34 FIRST SUPPORT PORTION
35 SECOND SUPPORT PORTION
36 FIXING COMPONENT
37 FLAT PLATE PORTION
38 CYLINDER PORTION
39 HOLE
40 SCREW HOLE
41 PLATFORM PORTION
42 HOLE
43 HOLE
44 SCREW HOLE

1. A ceiling fan comprising:
a support rod;
a motor disposed at a lower portion of the support rod;
a blade detachably coupled to the motor; and
a lighting unit disposed at a lower portion of the motor,
wherein the lighting unit includes:
an upper lighting cover;
a lower lighting cover that covers an area below the upper lighting cover;
a board disposed between the lower lighting cover and the upper lighting cover; a light-emitting component is disposed on the board; and
a heat-dissipating unit disposed between the board and the upper lighting cover, the heat-dissipating unit is configured to dissipate heat from the board,
wherein the upper lighting cover and the lower lighting cover each comprises a resin, and
wherein the upper lighting cover has a center portion with an opening to dissipate heat.

2. The ceiling fan of claim 1,
wherein the upper lighting cover includes a protrusion portion protruding upward at the center portion, and
wherein the opening is arranged at the protrusion portion.

3. The ceiling fan of claim 1,
wherein the opening faces a lower surface of the motor, the opening being inside of a peripheral portion of the motor from a top view.

4. The ceiling fan of claim 1,
wherein the lighting unit is detachably coupled to a lower end portion of the support rod.

5. The ceiling fan of claim 1, further comprising:
a controller disposed over the motor.
